(19) United States
(12) Patent Application Publication
(10) Pub. No.: US 2006/0256718 A1
(43) Pub. Date: Nov. 16, 2006

(54) Apparatus for Regulating Bandwidth

(76) Inventors: David R. Hall, Provo, UT (US); Monte L. Johnson, Orem, UT (US); David B. Bartholomew, Springville, UT (US); Roger O. Koehler, Cottonwood Heights, UT (US)

Correspondence Address: JEFFREY E. DALY;INTELLISERV, INC, 400 N. SAM HOUSTON PARKWAY EAST, SUITE 900, HOUSTON, TX, 77060, US

(21) Appl. No.: 10/908,532

(22) Filed: May 16, 2005

(51) Int. Cl. H04L 12/26

(52) U.S. Cl. 370/230; 370/468

(57) ABSTRACT

An apparatus comprises a modem intermediate and in communication with a plurality of data sources within the apparatus and a network external to the apparatus. The apparatus further comprises one of a plurality of bandwidth regulators intermediate and in communication with each data source and the modem. Each bandwidth regulator comprises a transmission limit and is adapted to limit data transmission from the data source to the modem. A method for regulating bandwidth usage by data sources in a node in a downhole network along a downhole tool string is also disclosed. The method comprises providing a modem, providing a bandwidth regulator, setting a transmission limit within each bandwidth regulator, and limiting a rate of data transmission. The modem is intermediate and in communication with a plurality of data sources and the downhole network, and the bandwidth regulator is intermediate and in communication with each data source and the modem.

### BACKGROUND OF THE INVENTION

The present invention relates to the field of networking, and in particular to regulation and control of bandwidth usage. It is particularly useful in downhole networks along a tool string where computational ability may be limited.

In any network, the amount of information which can be transmitted at a given time is generally referred to as bandwidth or throughput. Bandwidth is often expressed in terms of bytes per second, kilobytes per second, or megabytes per second. Many systems which regulate bandwidth are known in the patent art, and these systems may be referred to in separate categories.

A first category includes references which disclose one device controlling over a network the bandwidth usage of another device. An example of such a system is U.S. Pat. No. 6,282,208, which is herein incorporated by reference for all that it discloses. The '208 patent discloses a method and apparatus wherein traffic statistics are kept by a routing mechanism as credits that are only updated as needed, and each cable modem in the network is assigned a limit on the maximum amount of traffic that it may transmit and receive. When that limit is exceeded, traffic for that modem will no longer be allowed by the routing mechanism to pass through the system. Other examples of such systems are disclosed in the following U.S. Pat. Nos. 6,801,500, 6,778,494; which are both incorporated herein for all that they disclose.

A second category includes references which disclose a transmitter controlling its own transmission. An example of such a system is disclosed in U.S. Pat. No. 5,946,297, which is herein incorporated by reference for all that it discloses, wherein scheduling is controlled by a dual scheduling mechanism having a first scheduler, triggered by absolute time, for scheduling the minimum service connections up to a rate corresponding to their reserved minimum bandwidth, a second scheduler and a queue of minimum service connection identifiers for communication between the two scheduling schemes.

Another example of a system controlling its own transmission is disclosed U.S. Pat. No. 6,002,667, which is herein incorporated by reference for all that it discloses. The '667 patent discloses a method and apparatus wherein a buffer pool disposed in a receiver is divided among a first portion dedicated for allocated bandwidth cell traffic and a second portion for dynamic bandwidth cell traffic. The transmitter maintains a count of available space in the buffer pool, and the count is updated periodically over the network.

Also, U.S. Pat. No. 6,400,725 discloses a method and apparatus wherein a protocol forces a “fairness” delay between sequential transmissions from a device, thereby allowing another device to gain access to the communications channel during this fairness delay period. The '725 patent is herein incorporated for all that it discloses.

### BRIEF SUMMARY OF THE INVENTION

An apparatus comprises a modem intermediate and in communication with a plurality of data sources within the apparatus and a network external to the apparatus. The apparatus further comprises one of a plurality of bandwidth regulators intermediate and in communication with each data source and the modem. Each bandwidth regulator comprises a transmission limit and is adapted to limit data transmission from the data source to the modem.

The apparatus may be in a downhole component, located in the bore of the component, integrated into the wall of the component, attached to the outside of the component, or combinations thereof. The term “tool port” is herein intended to refer to an interface with a peripheral device. Examples of peripheral devices which may interface to the apparatus may be downhole tools such as motors, jars, flow meters, or seismic equipment. In general, the data sources may be tool ports, local node circuitry, sensors, wireless transceivers, or combinations thereof.

The network may be a wireless network, a local area network, a satellite network, the internet, a downhole network, or a combination thereof, and the network may be integrated into a downhole tool string. The downhole tool string may be selected from the group consisting of rigid pipes, coiled tubing, production tubing, and combinations thereof.

In general, a network may have a limit to the amount of data which can be transmitted per unit time. This limit is commonly called the bandwidth or maximum bandwidth of the network. There may also be other limitations of the bandwidth available to the apparatus, such as in a multi-node network where each node is limited to a portion of the bandwidth of the network. The term “maximum available bandwidth” is herein intended to refer to the portion of the bandwidth of the network available to the apparatus.

The transmission limit may be changed by a device located internal to the apparatus, remotely over the network, or combinations thereof. The transmission limit may be selected from the group consisting of a number of bytes per unit time, a number of bits per unit time, a number of packets per unit time, percentage of time, percentage of maximum available bandwidth, and combinations thereof.

The bandwidth regulator may comprise a limiter, and the limiter may be selected from the group consisting of switches, data buffers, logic gates, routers, processors, computer algorithms, and combinations thereof. The bandwidth regulator may further comprise at least one counter, and the at least one counter may perform a function selected from the group consisting of counting units of data, counting oscillations of a crystal, counting electric pulses, counting units of time, and combinations thereof. It is generally understood that a counter which counts oscillations of a crystal or regular electronic pulses may track the passage of time and for purposes of this specification such a counter may also be referred to as a timer. The apparatus may comprise at least one counter in communication with multiple bandwidth regulators within the apparatus.

Also disclosed is a downhole tool string comprising a network, and at least one component comprising a modem intermediate and in communication with the network and a plurality of data sources within the component. The network is along the tool string and the at least one component further comprises one of a plurality of bandwidth regulators intermediate and in communication with each data source and the modem. Each bandwidth regulator may comprise a transmission limit, a limiter, and a counter.

A method for regulating bandwidth usage by data sources in a node in a downhole network along a downhole tool string is also disclosed. The method comprises providing a modem, providing a bandwidth regulator, setting a transmission limit within each bandwidth regulator, and limiting a rate of data transmission from a data source. The modem is intermediate and in communication with a plurality of data sources and the downhole network, and the bandwidth regulator is intermediate and in communication with each data source and the modem. The rate of data transmission is limited by the corresponding bandwidth regulator, according to the transmission limit.

The method may further comprise the step of tracking the rate of data transmission. Tracking the rate of data transmission may be performed by at least one counter. The transmission limit may be set by a device selected from the group consisting of the node, devices in communication with the node over the network, and combinations thereof.

The step of limiting the rate of data transmission may comprise steps selected from the group consisting of truncating data, discarding data, signaling the data source, determining if the transmission limit is about to be reached, storing data in a buffer, routing data to another device for later transmission, and combinations thereof.

The method may further comprise the step of limiting requests of data from each data source to those achievable within the transmission limit. The step of limiting requests of data from each data source may be performed by the node, remote devices over the network, or combinations thereof.

### BRIEF DESCRIPTION OF THE DRAWINGS

FIG. 1 is a block diagram of the apparatus.

FIG. 2 is a perspective view of a downhole component, comprising the apparatus.

FIG. 3 is block diagram of a network in a downhole tool string.

FIG. 4 is a block diagram of the apparatus in a downhole component.

FIG. 5 is a block diagram of a limiter.

FIG. 6 is a block diagram of an embodiment of a limiter.

FIG. 7 is a block diagram of an embodiment of a limiter.

FIG. 8 is a block diagram of a bandwidth regulator.

FIG. 9 is a block diagram of an embodiment of a bandwidth regulator.

FIG. 10 is a block diagram of an embodiment of a bandwidth regulator.

FIG. 11 is a block diagram of an embodiment of a bandwidth regulator.

FIG. 12 is a block diagram of an embodiment of a bandwidth regulator.

FIG. 13 is a block diagram of an embodiment of a bandwidth regulator.

FIG. 14 is a flowchart of a method for regulating bandwidth.

FIG. 15 is a flowchart of a method for regulating bandwidth.

FIG. 16 is a flowchart of a method for regulating bandwidth.

FIG. 17 is a flowchart of a method for regulating bandwidth.

### DETAILED DESCRIPTION OF THE INVENTION AND THE PREFERRED EMBODIMENT

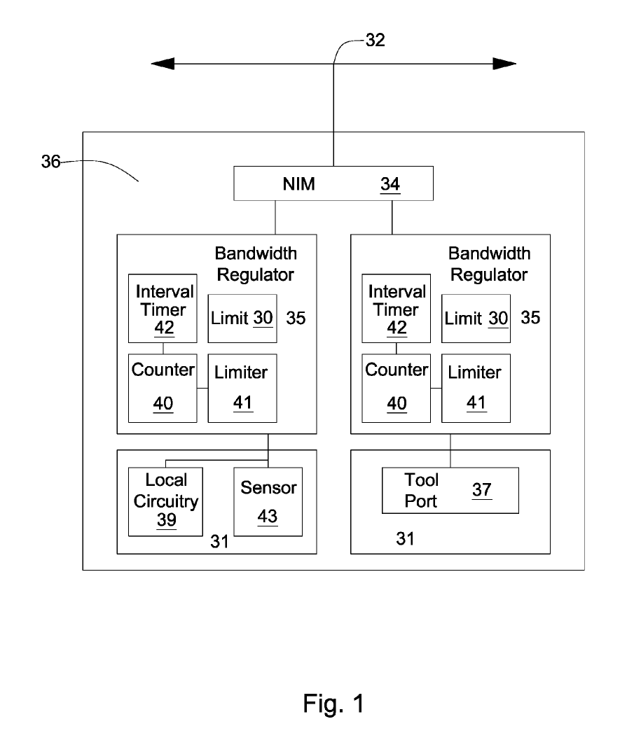

FIG. 1 illustrates an apparatus 36 connected to a network 32. The apparatus 36 comprises a network interface modem (NIM) 34 intermediate and in communication with a plurality of data sources 31 within the apparatus 36. In general, the data sources 31, may be or comprise tool ports 37, local node circuitry 39, sensors 43, wireless transceivers (not shown), or combinations thereof. A tool port 37 is an interface with a peripheral device. The interface may be wires or other electrical connectors to which a tool (not shown) may connect. A tool port 37 may pass information between the peripheral device and the NIM 34. The tool port 37 may pass the information without altering it, or may convert the information to a specific form such as packets or convert the information to a specific communications standard which may be required by the tool. The tool port 37 may have additional circuitry for performing functions such as determining if a tool is connected, determining the state (i.e. power level, mode of operation, etc.) of the tool, or changing the state (i.e. power on/off, reset, etc.) of the tool. Local node circuitry 39 may be circuitry for monitoring the NIM 34, or turning on or off the tool port 37 or sensors 43. The local node circuitry 39 may keep track of how many tools are connected, as well as data transmission statistics such as bit error rates or dropped packets.

The network 32 is external to the apparatus 36 and may be a wireless network, a local area network, a satellite network, the internet, a downhole network, or a combination thereof. Being connected to a network 32 such as a local area network, a wireless network or a downhole network may be advantageous as it may allow remote monitoring and control of bandwidth usage. In situations such as oil and gas drilling and exploration, remote monitoring and control may be advantageous, as it may be done while drilling and may save time and money. Similarly, being connected to the internet or a satellite network may be advantageous as it may allow bandwidth usage to be monitored and controlled from anywhere in the world. For example, an oil company may be able to monitor from the headquarters of the company bandwidth usage of several of its drill strings located in several different countries. This may result in significant savings in airfare, accommodations, and wages of personnel that may otherwise need to be present at each site for monitoring.

The apparatus 36 further comprises one of a plurality of bandwidth regulators 35 intermediate and in communication with each data source 31 and the NIM 34. Each bandwidth regulator 35 comprises a transmission limit 30 and may further comprise a limiter 41. The limiter 41 is adapted to limit data transmission from the data source 31 to the NIM 34.

Still referring to FIG. 1 the bandwidth regulator 35 comprises a counter 40 and an interval timer 42. The counter 40 may count units of data, and the interval timer 42 may count oscillations of a crystal, count electric pulses, count units of time, or combinations thereof. In general, the interval timer 42 may reset the counter 40 at regular intervals of time, and the counter 40 may track the number of bytes transmitted from the data source 31 to the NIM 34.

In general, the data being transmitted from the data sources 31 may be formed into packets to be transmitted over the network 32, or may be raw data to be formed into packets after passing the bandwidth regulators 35. The bandwidth regulators 35 may therefore count packets or units of raw data such as bits or bytes according to what is being transmitted.

The transmission limit 30 may preferably be a number of bytes per unit time. The transmission limit may alternatively be a number of bits per unit time, a number of packets per unit time, percentage of time, percentage of maximum available bandwidth, or combinations thereof. The transmission limit 30 may be represented in several ways. One representation of a transmission limit 30 may be a number of bytes to be counted by the counter 40, and an interval of time counted by the interval timer 42. Alternatively, if the interval of time counted by the interval timer 42 is considered to be constant, another representation of the transmission limit 30 may be the number of bytes to be counted by the counter 40. If the number of bytes counted by the counter 40 is considered to be constant, another representation of the transmission limit 30 may be the interval of time to be counted by the interval timer 42. The interval timer 42 and the counter 40 may count from zero up to the value specified by the transmission limit 30 or count from the value specified by the transmission limit 30 down to zero. The limiter 41 may limit transmission from the data source 31 when the rate specified by the transmission limit 30 has been reached or exceeded, and may allow transmission otherwise.

For example, a transmission limit 30 may be 1000 bytes per second. The interval timer 42 may count from zero to one second, and then reset the counter 40. The counter 40 may count the number of bytes transmitted from the data source 31 to the NIM 34. If the counter 40 reaches 1000 bytes before being reset by the interval timer 42, the limiter 41 may stop transmission until the interval timer 42 resets the counter 40. Thus, the number of bytes transmitted per second may be limited to 1000, and thereby the transmission rate from the data source 31 may be limited to 1000 bytes per second.

The preceding example also illustrates the bursting capability of the present invention. The frequency of bursts may be controlled by adjusting the interval of time counted by the interval timer 42, and the amount of information transmitted in each burst may be controlled by adjusting the number of bytes counted by the counter 40. Thus, a transmission limit 30 of 1000 bytes per second may be implemented as in the previous example, or for example may be implemented as the interval timer 42 counting from zero to one half of a second, and the limiter 41 stopping transmission when the counter 40 reaches 500. Many other implementations may achieve a transmission limit 30 of 100 bytes per second.

Still referring to FIG. 1 a transmission limit 30 may be a percentage of the maximum available bandwidth. An example of a transmission limit 30 which is a percentage of maximum available bandwidth may be a transmission limit 30 which is 50% of maximum available bandwidth of 1000 bytes per second 50% of 1000 bytes per second is 500 bytes per second, and may be implemented in a variety of ways as seen in the previous example. The 500 bytes per second of this example may be calculated by the apparatus 36 or other devices located remotely over the network 32.

Limiting the transmission from a data source 31 may be useful to ensure communication from each data source 31. For example, a sensor 43 may be able to generate information as fast as or faster than the NIM 34 may transmit, and may prevent a tool port 37 from transmitting by consuming all available bandwidth. However, if transmissions from the sensor 43 to the NIM 34 are limited, the tool port 37 may be able to transmit information as well.

It may be convenient to change the transmission limits 30 of the bandwidth regulators 35 according to need. For example, a higher transmission limit 30 may be needed in the bandwidth regulator 35 associated with the tool port 37 when the tool port 37 is in use, and the transmission limit 30 in the bandwidth regulator 35 associated with other data sources 31 may be lowered accordingly. When the tool port 37 is no longer in use, the associated transmission limit 30 for the tool port 37 may be lowered, and the other transmission limits 30 may be raised.

The transmission limit 30 may be changed by a device located internal to the apparatus 36, remotely over the network 32, or combinations thereof. For example, the transmission limit 30 may be determined by a device located remotely over the network 32 and in communication with the apparatus 36 over the network 32. For example the device which determines the transmission limit 30 may be located in surface equipment when the apparatus is located in a downhole component. Alternatively, the apparatus 36 may determine the transmission limits 30. The apparatus 36 may determine the transmission limit 30 based on what information is requested, or on the maximum bandwidth available to it.

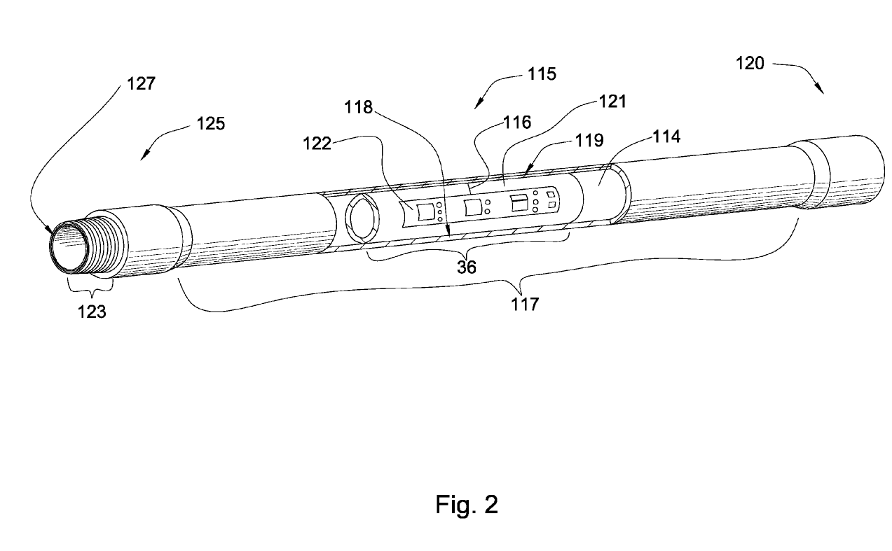

As seen in FIG. 2, the apparatus 36 may be in a downhole component 115. The component 115 may have a pin end 125 and a box end 120, and the pin end 125 may have a threaded portion 123 designed to mate with a box end 120 of similar components. The component 115 may have inductive coils 127 connected by electrical conductors 119, which may serve as a network 32 (as described in FIG. 1). A system of inductive coils which may serve as a network and may be used with the present invention may be seen in U.S. Pat. No. 6,670,880 to Hall, et. al. which is herein incorporated by reference for all that it discloses. Other networks along downhole tool strings may also be used with the present invention, such as direct electrical networks, acoustic networks, mud pulse networks, short-hop networks, and combinations thereof.

The apparatus 36 may be located in a bore 114 of the component 115, such as in a module 121 inserted into a body 117 of the component 115. It may be advantageous to locate the bulk of apparatus 36 in the bore 114 of the component 115 where it may be protected from scraping against rocks or sides of a well bore. A connection 116 may connect circuitry 122 on module 121 to wire 119 in wall 118 of the component 115. It may be advantageous to integrate the apparatus 36 into the wall 118 of the component 115 such as in grooves or recesses in the wall 118, which may reduce the size of the module 121, and reduce constriction of drilling fluid which may flow through the bore 114 of the component 117. It may also be advantageous to have portions of the apparatus 36 attached to the outside of the component 115, such as a tool port 37 (see FIG. 1) which may interface with a tool (not shown) external to the component 115.

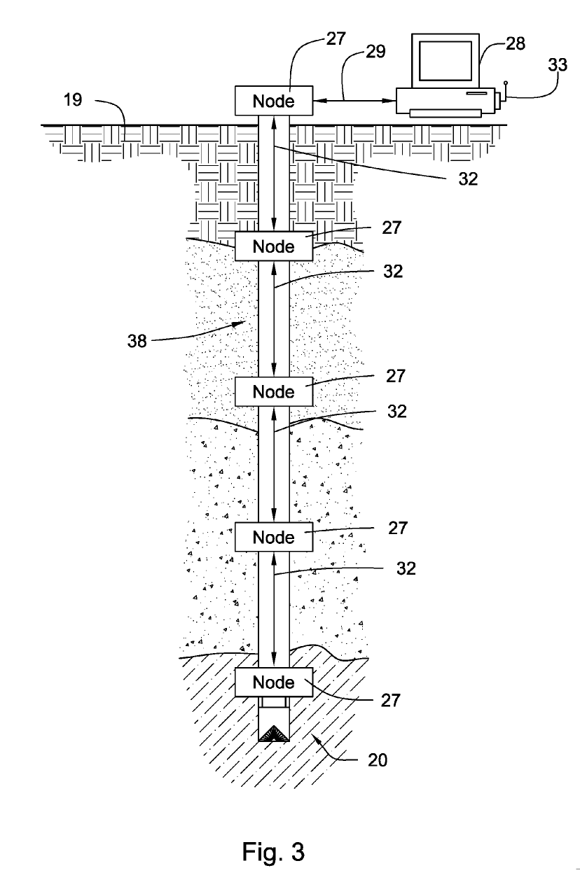

As seen in FIG. 3, the network 32 may be integrated into a downhole tool string 38. The tool string 38 may comprise components selected from the group consisting of rigid pipes, coiled tubing, production tubing, and combinations thereof. The tool string 38 may be a drill string, and may have a drill bit 20 for drilling into earth 19. A computer 28 may also comprise a connection 29 to the network 32 in the tool string 38, and may comprise a connection 33 to another network such as a wireless network, a local area network, a satellite network, or the internet.

The downhole tool string 38 may comprise at least one node 27 comprising a modem 34 (see FIG. 1) intermediate and in communication with the network 32 and a plurality of data sources 31 within the node 27. The node 27 may further comprises one of a plurality of bandwidth regulators 35 intermediate and in communication with each data source 31 and the modem 34.

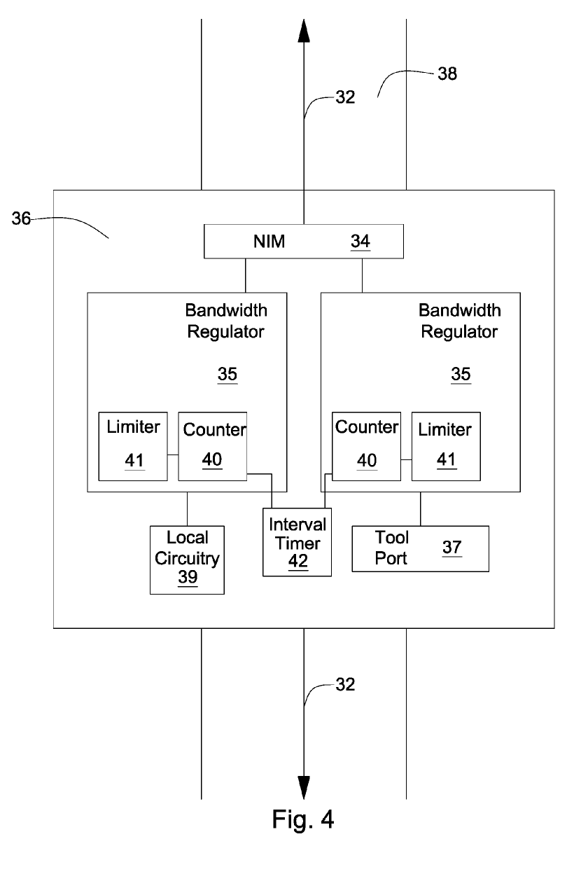

FIG. 4 illustrates an apparatus 36 which comprises at least one interval timer 42 in communication with multiple bandwidth regulators 35 within the apparatus 36. The interval timer 42 may be in communication with multiple counters 40. The interval timer may reset multiple counters 40 simultaneously. Alternatively, the counters 40 may reset themselves when the interval specified by the transmission limit 30 is reached. The counters 40 may count to different transmission limits for the tool port 37 and local circuitry 39 and the limiter 41 may limit the transmission. The NIM 34 may be in communication with a network 32 along a downhole tool string 38.

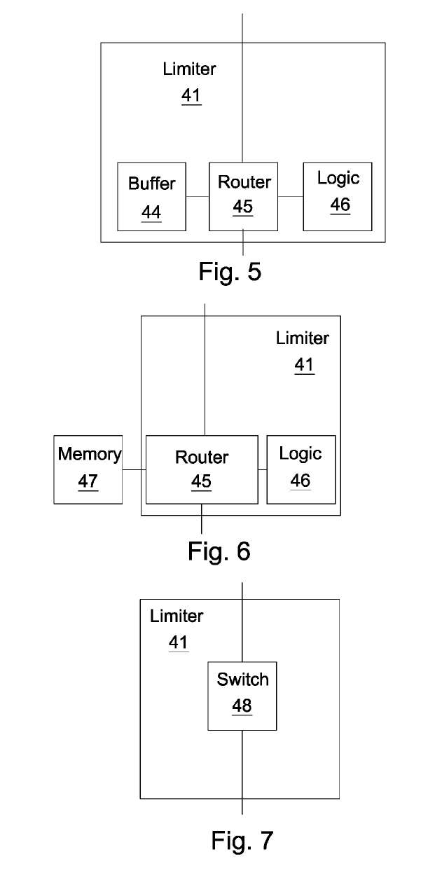

A limiter 41 may be selected from the group consisting of switches, data buffers, logic gates, routers, processors, computer algorithms, and combinations thereof. FIGS. 5, 6 and 7 illustrate a few arrangements of a limiter 41.

FIG. 5 illustrates a limiter 41 comprising a buffer 44, a router 45, and control logic 46. The logic 46 may receive a signal from a counter 40 (see FIG. 1) and signal the router 45 to route the data into the buffer 44. When it is once again clear to transmit, the logic 46 may signal the router 45, which may then transmit the information stored in the buffer 44.

FIG. 6 illustrates a limiter 41 having a router 45 and logic 46. The router 45 is connected to memory 47 external to the limiter 41. Data may be stored in the memory 47 for later processing or for being sent to the NIM 34 (show previously) after the counter 40 (also shown previously) has been reset.

FIG. 7 illustrates a limiter 41 comprising a switch 48. A signal may be received from a counter 40 that the transmission limit is reached, and the switch 48 may simply break the connection over which data may travel. This may cause data being transmitted from a data source 31 to be lost or discarded.

A limiter 41 may alternatively be implemented as a processor such as a microcontroller or as computer algorithms. A limiter 41 implemented as a processor or a computer algorithm may perform the same functions as described in FIGS. 5, 6, and 7.

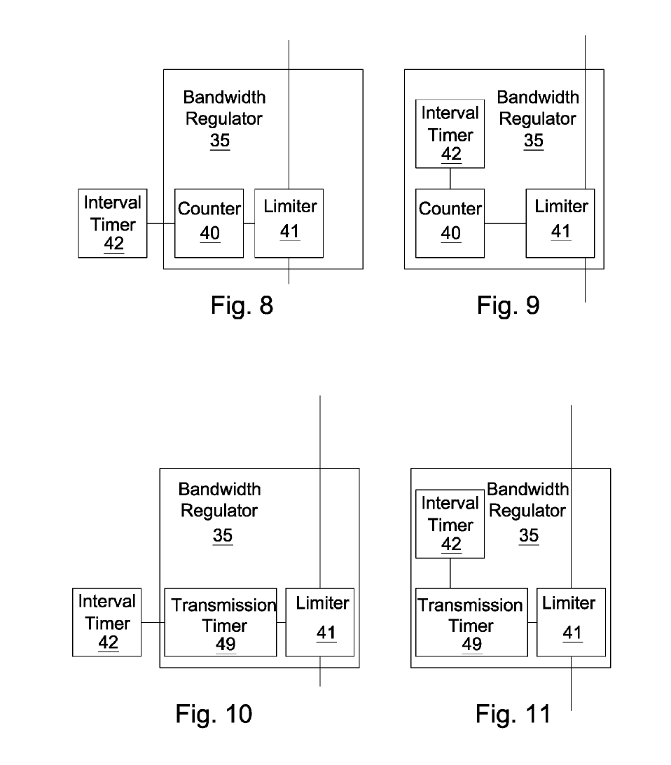

FIGS. 8 through 13 illustrate a few embodiments of a bandwidth regulator 35. FIG. 8 shows a bandwidth regulator 35 comprising a limiter 41, and a counter 40, and connected to an interval timer 42 external to the bandwidth regulator 35. As previously discussed, the interval timer 42 may reset the counter 40 at a regular interval of time, and the counter 40 may signal the limiter 41 when the limit has been reached. As seen in FIG. 9, the interval timer 42 may be internal to the bandwidth regulator 35.

FIG. 10 illustrates a bandwidth regulator 35 comprising a limiter 41 and a transmission timer 49, which is connected to an interval timer 42 external to the bandwidth regulator 35. The transmission limit 30 discussed previously may be represented as a percentage of time. The transmission timer 49 may simply keep track of a length of time during which an associated data source 31 may transmit, and may stop the transmission when the time has been reached. The interval timer 42 may then restart the transmission timer 49 periodically. As seen in FIG. 11, the interval timer 42 may be internal to the bandwidth regulator 35.

An example of a transmission limit 30 as a percentage of time may be a transmission limit 30 of 50%. The interval timer 42 may count from zero to one second, and then reset the transmission timer 49. The transmission timer 49 may count from zero to 0.5 seconds, and then signal the limiter 41 to limit transmission. Thus, for half of every second transmission is allowed, thereby allowing transmission for 50% of the time.

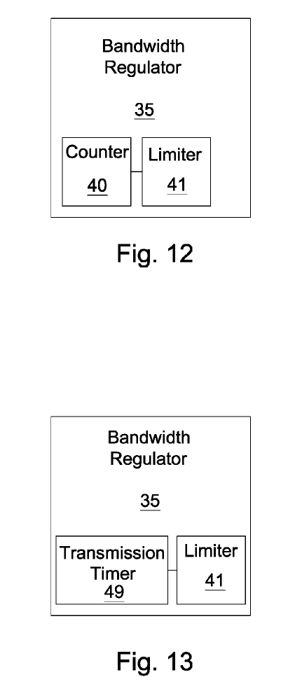

FIG. 12 illustrates a bandwidth regulator 35 having a counter 40 and a limiter 41. The counter 40 may be reset by an external event. An external event may be the receipt of a packet in the NIM 34 or a command from local circuitry 39. Such an arrangement may be less regular in the control of the transmission, but may be advantageous as it may reduce the complexity of the apparatus 36. Alternatively, the bandwidth regulator 35 may comprise a transmission timer 49 and a limiter 41 as seen in FIG. 13, and the transmission timer may be reset by an external event.

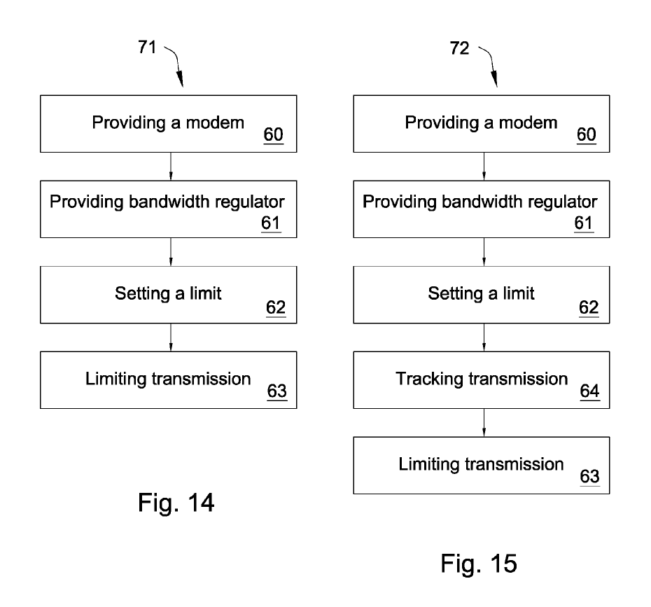

FIG. 14 illustrates a method 71 for regulating bandwidth usage by data sources 31 in a node 27 in a downhole network 32 and references FIG. 1 and FIG. 3. The method 71 comprises providing 60 a modem 34, providing 61 one of a plurality of bandwidth regulators 35, setting 62 a transmission limit 30 within each bandwidth regulator 35, and limiting 63 a rate of data transmission from a data source 31. The modem 34 is intermediate and in communication with a plurality of data sources 31 and the downhole network 32. The bandwidth regulator 35 is intermediate and in communication with each data source 31 and the modem 34. The rate of data transmission is limited by the corresponding bandwidth regulator 35, according to the transmission limit 30. The transmission limit 30 may be set by a device selected from the group consisting of the node 27, devices such as a computer 28 or another node in communication with the node 27 over the network 32, and combinations thereof.

FIG. 15 illustrates a method 72 for regulating bandwidth usage which comprises the steps of providing 60 a modem 34, providing 61 one of a plurality of bandwidth regulators 35, setting 62 a transmission limit 30, and limiting 63 a rate of data transmission as previously discussed and references FIG. 1 and FIG. 3. The method 72 may further comprise the step of tracking 64 the rate of data transmission. Tracking 64 the rate of data transmission may be counting the number of units of data transmitted per unit time, and may be performed by either a counter 40 or interval timer 42 or both. For example, a counter 40 may count a number of bytes being transmitted, and another counter such as an interval timer 42 may count to one second. The rate of data transmission may be recorded in a location such as a memory 47 (see FIG. 6) for later analysis.

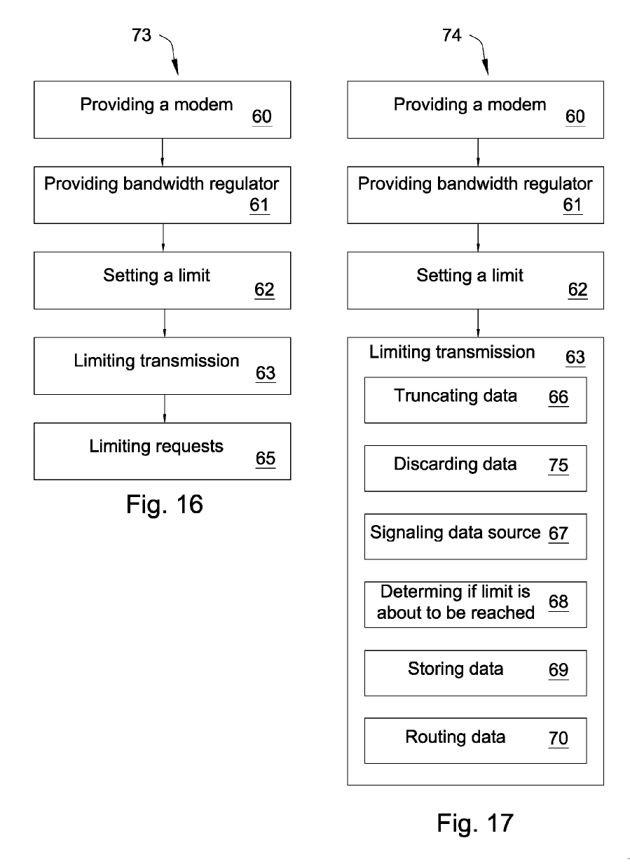

FIG. 16 illustrates a method 73 for regulating bandwidth usage which comprises the steps of providing 60 a modem 34, providing 61 one of a plurality of bandwidth regulators 35, setting 62 a transmission limit 30, and limiting 63 a rate of data transmission as previously discussed and references FIG. 1 and FIG. 3. The method 73 may further comprise the step of limiting 65 requests of data from each data source 31. The requests may be limited 65 to those requests achievable within the transmission limit 30.

An example of a request not achievable within a transmission limit 30 may be requesting data from a sensor 43 five times per second. The data from the sensor 43 may be twenty-five bytes in length, and the transmission limit 30 in the associated bandwidth regulator 35 may be 100 bytes per second. Therefore the request for data from a sensor 43 may require 130 bytes per second, and may not be achievable within the transmission limit 30.

The step of limiting 65 requests of data from each data source may be performed by the node, remote devices over the network, or combinations thereof. In response to a request which is not achievable within a transmission limit 30, the node 27 may not process the request, reply that the request is unachievable, or both. Another device located remotely over the network 32 may limit itself from making requests which are not achievable within the transmission limit 30.

An example of a device limiting itself from making requests may be a computer 28 in communication with a node 27 over the network 32. A user may request the computer 28 to make a request for data from the node 27 which is not achievable within the transmission limit 30. The computer 28 may have a record of the transmission limit 30 and may respond to the user that the request is unachievable without communicating with the node 27 over the network 32.

FIG. 17 illustrates a method 74 for regulating bandwidth usage which comprises the steps of providing 60 a modem 34, providing 61 one of a plurality of bandwidth regulators 35, setting 62 a transmission limit 30, and limiting 63 a rate of data transmission as previously discussed and references FIG. 1 and FIG. 3. The step of limiting 63 transmission may comprise steps selected from the group consisting of truncating 66 data, discarding 75 data, signaling 67 the data source 31, determining 68 if the transmission limit 30 is about to be reached, storing 69 data in a buffer 44 (FIG. 5), routing 70 data to another device for later transmission, and combinations thereof.

The step of truncating 66 data may be stopping the data from going to the modem 34 as with a switch 48 (FIG. 7), and may result in data being lost. The step of discarding 75 data may be the result of truncating 66 data, or may be deleting data from a buffer 44 or memory (FIG. 6). The step of signaling 67 the data source 31, may be to indicate that the transmission limit 30 has been reached and to stop transmitting. As the data may be truncated 66, signaling 67 the data source 31 may be advantageous to prevent more data from being lost.

Packets may have specific ending bytes and may be ignored if transmission is stopped in the middle. Therefore, the step of determining 68 if the transmission limit 30 is about to be reached may be advantageous if a packet is about to be transmitted which may require more than the transmission limit 30 will allow. The data source may be signaled 67 to indicate that the packet will not be allowed. Alternatively, the packet currently being transmitted may be allowed to overrun the transmission limit 30 until the ending bytes are reached.

Data may be stored 69 temporarily in a buffer 44, for longer periods of time in a device such as memory 47. A router 45 (FIG. 5) may be used for routing 70 data to a buffer 44 or to memory 47.

Whereas the present invention has been described in particular relation to the drawings attached hereto, it should be understood that other and further modifications apart from those shown or suggested herein, may be made within the scope and spirit of the present invention.

What is claimed is:

1. An apparatus comprising:
a modem intermediate and in data communication between each of a plurality of data sources within the apparatus and a network external to the apparatus;
one of a plurality of bandwidth regulators intermediate and in communication with each data source and the modem; and
each bandwidth regulator comprising a transmission limit and adapted to limit data transmission from the data source to the modem.

2. The apparatus of claim 1 wherein the apparatus is in a downhole component.

3. The apparatus of claim 2 wherein the apparatus is located in a bore of the downhole component, integrated into a wall of the downhole component, attached to an outside of the downhole component, and combinations thereof.

4. The apparatus of claim 1 wherein the data sources are selected from the group consisting of tool ports, local node circuitry, sensors, wireless transceivers, and combinations thereof.

5. The apparatus of claim 1 wherein the network is selected from the group consisting of wireless networks, local area networks, satellite networks, the internet, downhole networks, and combinations thereof.

6. The apparatus of claim 1 wherein the network is integrated into a downhole tool string, the tool string selected from the group consisting of rigid pipes, coiled tubing, production tubing, and combinations thereof.

7. The apparatus of claim 1 wherein the transmission limit may be changed by a device located internal to the apparatus, changed remotely over the network, or changed by combinations thereof.

8. The apparatus of claim 1 wherein the transmission limit is selected from the group consisting of a count of a number of bytes per unit time, a count of a number of bits per unit time, a count of a number of packets per unit time, a percentage of time, a percentage of maximum available bandwidth, and combinations thereof.

9. The apparatus of claim 1 wherein the bandwidth regulator further comprises a limiter selected from the group consisting of switches, data buffers, logic gates, routers, processors, computer algorithms, and combinations thereof.

10. The apparatus of claim 1 wherein the bandwidth regulator further comprises at least one counter.

11. The apparatus of claim 10 wherein the at least one counter performs a function selected from the group consisting of counting units of data, counting oscillations of a crystal, counting electric pulses, counting units of time, and combinations thereof.

12. The apparatus of claim 1 wherein the apparatus comprises at least one counter in communication with multiple bandwidth regulators within the apparatus.

13. A downhole tool string comprising:
a network along the tool string;
at least one component comprising a modem intermediate with and in communication with the network and a plurality of data sources within the component;
the at least one component further comprising one of a plurality of bandwidth regulators intermediate and in communication with each data source and the modem; wherein
each bandwidth regulator comprises a transmission limit, a limiter, and a counter.

14. A method for regulating bandwidth usage of data sources in a node in a downhole network along a downhole tool string, comprising the steps of:
providing a modem intermediate with and in communication with a plurality of data sources and the downhole network;
providing one of a plurality of bandwidth regulators intermediate and in communication with each data source and the modem;
setting a transmission limit within each bandwidth regulator; and
limiting by the bandwidth regulator a rate of data transmission of the corresponding data source, according to the transmission limit.

15. The method of claim 14 further comprising the step of tracking the rate of data transmission.

16. The method of claim 15 wherein the step of tracking the rate of data transmission is performed by at least one counter.

17. The method of claim 14 wherein the transmission limit is set by a device selected from the group consisting of the node, devices in communication with the node over the network, and combinations thereof.

18. The method of claim 14 wherein limiting the rate of data transmission is truncating data, discarding data, signaling the data source, determining if the transmission limit is about to be reached, storing data in a buffer, routing data to another device for later transmission, or combinations thereof.

19. The method of claim 14 wherein the method further comprises the step of limiting requests of data from each data source to those achievable within the transmission limit.

20. The method of claim 14 wherein the step of limiting requests of data from each data source is performed by the node, remote devices over the network, or combinations thereof.
